(19) United States
(12) Patent Application Publication
(10) Pub. No.: US 2012/0139348 A1
(43) Pub. Date: Jun. 7, 2012

(54) LOAD CONDITION CONTROLLED INLINE POWER CONTROLLER

(75) Inventor: Richard G. DuBose, Scottsdale, AZ (US)

(73) Assignee: IGO, INC., Scottsdale, AZ (US)

(21) Appl. No.: 13/308,207

(22) Filed: Nov. 30, 2011

Related U.S. Application Data
(60) Provisional application No. 61/418,829, filed on Dec. 1, 2010.

(51) Int. Cl. H02J 1/00

(52) U.S. Cl. 307/80

(57) ABSTRACT

In various embodiments, a power converter system that is configured to provide power to an electronic device is provided. The power converter system comprises a power converter and a power controller. The power converter is configured to condition power from a power source. The power converter is also be configured to transmit power to the electronic device. The power controller is configured to selectively or removably couple to the power converter between at least one of the power source and the electronic device. The power controller is also configured to disengage the power to the electronic device in response to the electronic device operating under a predetermined operating condition.

### CROSS-REFERENCE TO RELATED APPLICATIONS

This application is a non-provisional of U.S. Provisional Application No. 61/418,829, entitled “LOAD CONDITION CONTROLLER INLINE POWER ADAPTER,” which was filed on Dec. 1, 2010, and is hereby incorporated by reference for any purpose in its entirety.

### FIELD

The present invention relates to reducing power consumption in electronic devices. More particularly, the present invention relates to a circuit and method for disengaging power from a legacy power adapter if idle load conditions are present.

### BACKGROUND

The increasing demand for lower power consumption and environmentally friendly consumer devices has resulted in interest in power supply circuits with “green” technology. For example, on average, a notebook power adapter continuously “plugged in” spends 67% of its time in idle mode. Even with a power adapter which conforms to the regulatory requirement of dissipating less than 0.5 watts/hour, this extended idle time adds up to 3000 watt hours of wasted energy each year per adapter. When calculating the wasted energy of the numerous idle power adapters, the power lost is considerable.

Power adapters may be used to supply AC power from a power source, such as a wall outlet, to an electronic device. Similarly, inline power adapters may be used to supply DC power from a power converter or DC power source to an electronic device. Various electronic devices, including for example a computer, monitor, printer, scanner, and/or other electronic devices may be coupled to various power supplies that make use of various inline adapters. When not in use, these connected devices will often be left on and go into self-imposed idle modes that typically consume less than 1 watt/hr per device.

### SUMMARY

In various embodiments, a power converter system is configured to provide power to an electronic device. The power converter system comprises a power converter and a power controller. The power converter is configured to condition power from a power source. The power converter is also be configured to transmit power to the electronic device. The power controller is configured to selectively or removably couple to the power converter between at least one of the power source and the electronic device. The power controller is also configured to disengage the power to the electronic device in response to the electronic device operating under a predetermined operating condition. The predetermined operating conditions may include, for example, an idle mode, a sleep mode, or a predetermined battery charge threshold.

In various embodiments, the power controller is configured to measure a current drawn by the electronic device from at least one of the power source and the power converter. In exemplary embodiments, the power controller comprises a control circuit configured to monitor and disengage the power.

In various embodiments, the power controller may further comprise a user input in communication with the control circuit, and wherein in response to receiving an input from a user, the control circuit does not disengage power.

In various embodiments, a power controller is configured to removably couple between a power converter and an electronic device in order to reduce power consumption during idle operation of the electronic device. In these embodiments, the power controller comprises a power input that, when coupled to the power converter, is configured to receive power from at least one of a power supply and the power converter. The power controller also comprises a control circuit configured to monitor the power and disengage the power to the electronic device in response to the electronic device drawing substantially no power.

In various operating configurations, the power controller may be configured to receive the power from the power source and transmit the power to the power converter. In other operating configurations, the power controller is configured to receive the power from the power converter and transmit the power to the electronic device.

In various embodiments, the power controller is configured with a male connector to removably couple to the power source and a female connector to removably couple to the power converter.

In other embodiments, the power controller is configured as a cord. In these embodiments, the power converter comprises a power input wire and a power output wire. The power controller may be configured to replace at least one of the power input wire and the power output wire.

In various embodiments, a method for providing power to an electronic device is provided. The method may be performed by any suitable power controller system comprising a power converter and power controller. In operation, the power converter receives power to be provided to an electronic device. A control circuit of the power controller monitors the current drawn by the electronic device. In response to detecting a predetermined operating condition, the control circuit inhibits power to the electronic device.

### BRIEF DESCRIPTION OF THE DRAWINGS

A more complete understanding of the present invention may be derived by referring to the detailed description when considered in connection with the Figures, where like reference numbers refer to similar elements throughout the Figures, and:

FIG. 1A illustrates a block diagram of an exemplary inline power adapter controller;

FIG. 1B illustrates a power adapter coupled to an exemplary inline power adapter controller;

FIG. 2 illustrates a block diagram of a load condition controlled inline power adapter controller in accordance with an exemplary embodiment;

FIG. 3 illustrates a circuit diagram of an exemplary control circuit for use within an exemplary load condition controlled inline power adapter controller; and

FIG. 4 illustrates a block diagram of a load condition controlled inline power adapter controller in accordance with an exemplary embodiment.

### DETAILED DESCRIPTION

The present invention may be described herein in terms of various functional components and various processing steps. It should be appreciated that such functional components may be realized by any number of hardware or structural components configured to perform the specified functions. For example, the present invention may employ various integrated components, such as amplifiers, current sensors, and logic devices comprised of various electrical devices, e.g., resistors, transistors, capacitors, diodes and the like, whose values may be suitably configured for various intended purposes. In addition, the present invention may be practiced in any integrated circuit application. However for purposes of illustration only, exemplary embodiments of the present invention will be described herein in connection with a sensing and control system and method for use with inline power adapter circuits. Further, it should be noted that while various components may be suitably coupled or connected to other components within exemplary circuits, such connections and couplings can be realized by direct connection between components, or by connection through other components and devices located thereinbetween.

As used herein, “connector” includes any plug, socket, and/or adapter configured to convey power. The connector may be defined by various standards including for example, IEC 60320 published by the International Electrotechnical Commission of Geneva, Switzerland and the ANSI/NEMA WD 6-2002 published by the National Electrical Manufacturers association of Rosslyn, Va., U.S.A., both of which are herein incorporated by reference. Further, connector includes any and all connectors employed to provide power to a portable electronic device, including for example, a USB connector, a mini-USB connector, a micro-USB connector, a Magsafe® Connector, a barrel connector, and the like.

Furthermore, as used herein, “convey power” includes the transfer of power by a suitable conductor and/or the transfer of power via magnetic induction.

In an exemplary embodiment, an inline power adapter controller, which may also be referred to as a power controller, is configured to interface with legacy power adapters or power converters. The power controller is also configured to inhibit power in response to a predetermined set of rules, such as for example detecting an idle condition for approximately one (1) minute, detecting a sleep mode, and the like. Further, the inline power adapter controller may be configured with a user selectable control, which enables or disables the inline power adapter controller.

Legacy power adapters and/or power converters are provided with a variety of electronic devices, including for example laptop computers, mobile phones, printers, and many other electronic devices. The inline power adapter controller allows a user to retrofit an existing legacy power adapter with the inline power adapter controller to achieve a more efficient power management scheme. In an exemplary embodiment, the inline power adapter controller inhibits power consumption if an electronic device enters an idle or sleep mode. The inline power adapter controller further allows the user to achieve a desired green operation of his or her electronic device while avoiding the expense of replacing the devices standard power adapter.

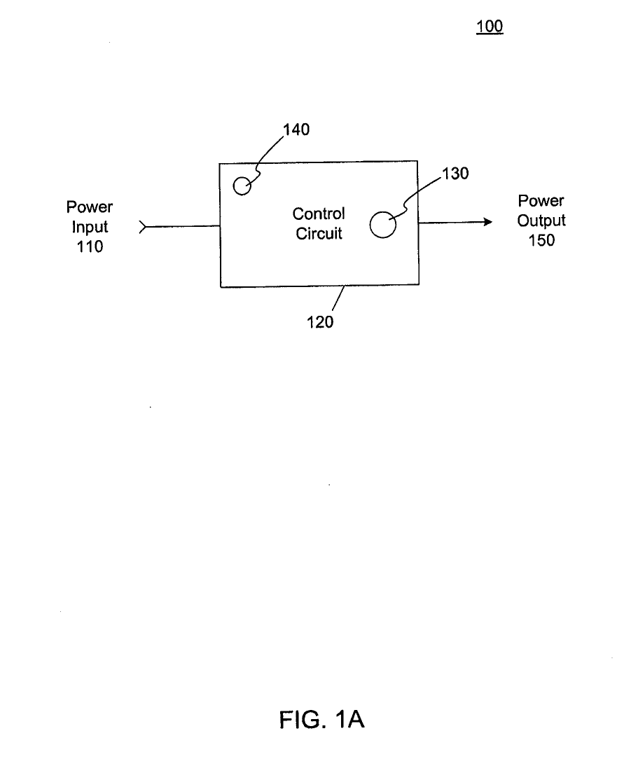

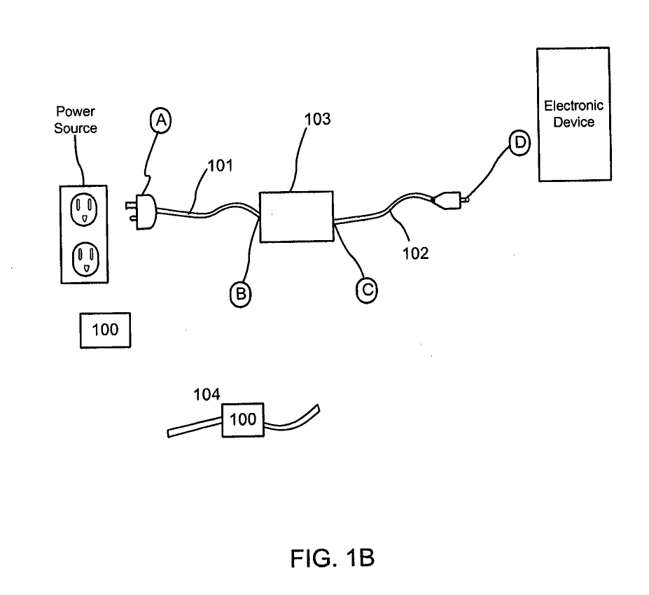

In an exemplary embodiment, a power controller configured for reducing or eliminating power during idle mode by disengaging the power input is disclosed. Inline power adapter controller 100 is any device configured to couple to an existing power adapter. In an exemplary embodiment and with reference to FIG. 1A, power controller 100 may be configured to convey power, monitor power consumption, and control (e.g. disable/enable) power, based on the power consumption needs of the device being supplied with power. For example, power controller 100 may be configured to couple to an existing laptop computer AC or DC power adapter. Power may be supplied to the laptop while the laptop is being actively used. Power may also be supplied to the laptop when the battery is charging. When the laptop is idle, power controller 100 may be configured to disengage the AC power supplied to the laptop. In response to power controller 100 disengaging power, the laptop may then consume battery power, or alternatively, may shut down and consume no power.

Various exemplary embodiments discussed herein will be described within the context of a laptop power adapter. However, it should be noted that the inline power adapter controller may be configured with any connectors suitable for conducting electricity. Similarly, inline power adapter controller may be coupled to any power adapter configured to provide AC and/or DC power to an electronic device.

In an exemplary embodiment and with reference to FIG. 1B, inline power adapter 100 is configured to couple to a legacy power adapter at any suitable location. A legacy power adapter may be any existing power supply that does not comprise inline power adapter 100.

In an exemplary embodiment, inline power adapter controller 100 is a component. Inline power adapter controller 100 may be configured to couple between a power source (e.g. a wall outlet) and a power adapter. For example and as shown in FIG. 1B, inline power adapter controller 100 is configured to removably couple between a power source and a power adapter at location A. In an exemplary embodiment, power adapter controller may be configured with one or more integral or interchangeable connectors in order to facilitate the connection between the power source and the power adapter.

In an exemplary embodiment, inline power adapter controller 100 is a component. Inline power adapter controller 100 may be configured to couple between power input wire 101 and transformer 103. For example and as shown in FIG. 1B, inline power adapter controller 100 is configured to removably between power input wire 101 and transformer 103 at location B. In an exemplary embodiment, power adapter controller may be configured with one or more integral or interchangeable connectors in order to facilitate the connection between power input wire 101 and transformer 103.

In an exemplary embodiment, inline power adapter controller 100 is a component. Inline power adapter controller 100 may be configured to couple between transformer 103 and power output wire 102. For example and as shown in FIG. 1B, inline power adapter controller 100 is configured to removably between transformer 103 and power output wire 102 at location C. In an exemplary embodiment, power adapter controller may be configured with one or more integral or interchangeable connectors in order to facilitate the connection between transformer 103 and power output wire 102.

In an exemplary embodiment, inline power adapter controller 100 is a wire or cord 104. Inline power adapter 100 may be configured to replace either power input wire 101 and/or power output wire 103. Moreover, cord 104 may configured with one or more integral or interchangeable connectors in order to facilitate the connection between a power source, transformer 103/power converter 103, and/or an electronic device.

In an exemplary embodiment, inline power adapter controller 100 is a component. Inline power adapter controller 100 may be configured to couple between a power adapter and an electronic device. For example and as shown in FIG. 1B, inline power adapter controller 100 is configured to removably couple between a power adapter and an electronic device at location D.

In an exemplary embodiment, and with reference again to FIG. 1A, an inline power adapter controller 100 comprises a power input 110, a control circuit 120, a user input 130, an indicator 140 and a power output 150. Power input 110 and power output 150 are each operatively coupled to control circuit 120 and to one another. Power input 110 and power output 150 are further configured to convey electrical power. User input 130 and indicator 140 may be electrically coupled to control circuit 120.

In an exemplary embodiment, power input 110 is any device suitably configured to couple to a power source, such as for example a laptop power adapter, and/or a wall outlet. Power input 110 may be configured to couple to an existing power supply. Specifically, power input 110 is configured to couple to the input of an existing power supply.

In an exemplary embodiment, power input 110 is any connector configured to convey power from a power source. Power input 110 may be configured to receive power from a power source, such as for example a typical three prong plug. Exemplary power input 110 is configured to convey power from the power source to control circuit 120.

In an exemplary embodiment, power output 150 connects to any device suitably configured to couple to a power source, such as for example a laptop power adapter, and/or a wall outlet. Power output 150 may be configured to couple to an existing power supply. Specifically, power output 150 is configured to couple to the transformer of an existing power supply.

Furthermore, in an exemplary embodiment, power output 150 is any connector configured to convey power to a transformer. Power output 150 may be configured to receive power via power input 110. Specifically, in an exemplary embodiment, power output 150 is configured to receive power through control circuit 120 and convey that power to a transformer.

In an exemplary embodiment, control circuit 120 is any electrical component or electrical assembly configured to control the input power to an electronic device. Control circuit 120 may be configured to monitor operating conditions of the electronic device. For example, control circuit 120 may be electrically coupled to a laptop power adapter. When the laptop is in use, control circuit 120 provides power to the laptop via power output to the adapter and monitors the operation of the laptop. Once the laptop enters an idle mode for a predetermined period of time, the control circuit is configured to inhibit and/or disable power to the laptop. A similar operating scheme may be employed when the laptop is commanded to enter a sleep mode. Further, in the context of an electronic device comprising a battery that requires charging, control circuit 120 may monitor the charge of the battery. Where the battery has a charge that is greater than or equal to a predetermined charge threshold, control circuit 120 inhibits power to the device during idle or sleep modes. In an exemplary embodiment, where the battery has a charge that is below a predetermined charge threshold, control circuit 120 allows the battery to charge until the battery reaches the predetermined threshold and thereafter, inhibit or disable the power provided to the electronic device.

In an exemplary embodiment, control circuit 120 comprises user input 130 and indicator 140. User input 130 may be device configured to receive a user input and communicate that input to control circuit 120. In one exemplary embodiment, user input 130 may be configured as an electro-mechanical input. For example, user input 130 may be a button or a switch. In an exemplary embodiment, user input 130 is configured to provide a variety of commands to control circuit 120. For example, user input 130, when selected by a user, may re-enable power through control circuit 120 after control circuit 120 had previously detected an idle and/or sleep condition and inhibited/disabled power to the electronic device. User input 130 may also be selected by a user to activate or de-activate control circuit 120. Under conditions where a user would not want power inhibited when control circuit 120 detected a idle conditions, the user may select user input 130 to disable control circuit 120. User input 130 may also be configured as an infrared or RF receiver, or a motion or light detector.

In an exemplary embodiment, indicator 140 is any device configured to indicate an operating condition and/or input. For example, indicator 140 may be a light emitting diode which is electrically coupled to control circuit 120. Indicator 140 may be illuminated when power is being supplied to an electronic device through control circuit 120 and may be dark (e.g. not-illuminated) where power is inhibited by control circuit 120 in response to an idle and/or sleep condition. Further, in an exemplary embodiment, indicator 140 illuminates in a variety of colors in response to a variety of inputs. For example, where a user has deactivated control circuit 120 via user input 130, indicator 140 may have a red indicator providing notice to the user that control circuit 120 is not active. Further, indicator 140 may have a yellow indicator that illuminates for a predetermined period of time after an idle condition is detected before power is inhibited by control circuit 120.

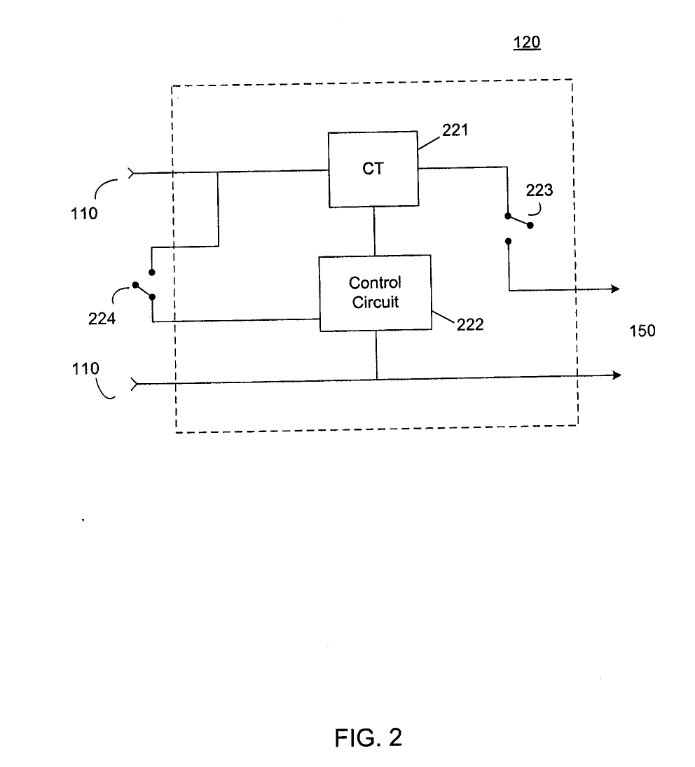

In an exemplary embodiment, and with reference to FIG. 2, inline power adapter controller 100 comprises power input 110 communicatively coupled to control circuit 120, which in turn is communicatively coupled to power output 150. Power output 150 may also be connected or otherwise coupled to a ground line and a neutral line in one embodiment. In an exemplary embodiment, control circuit 120 comprises a current measuring system 221, a control circuit 222, and a switch 223. In an exemplary embodiment and for illustration purposes, current measuring system 221 comprises a current transformer 221 having a primary circuit and a secondary winding. However, current measuring system 221 may also comprise a resistor with a differential amplifier, a current sensing chip, a Hall-effect device, or any other suitable component configured to measure current as now known or hereinafter devised. Current transformer 221 provides an output power level signal that is proportional to the load at power output 150. Furthermore, switch 223 connects the primary circuit of current transformer 221 to power output 150.

In an exemplary embodiment, control circuit 222 comprises at least one of, or a combination of: a latching circuit, a state machine, and a microprocessor. In one embodiment, control circuit 222 monitors the condition of the secondary winding of current transformer 221 and/or input voltage 110 and controls the operation of switch 223. Furthermore, in an exemplary embodiment, control circuit 222 receives a low frequency or DC signal from current transformer 221. The low frequency signal, for example, may be 60 Hz. This low frequency or DC signal is interpreted by control circuit 222 as the current required by the load at power output 150.

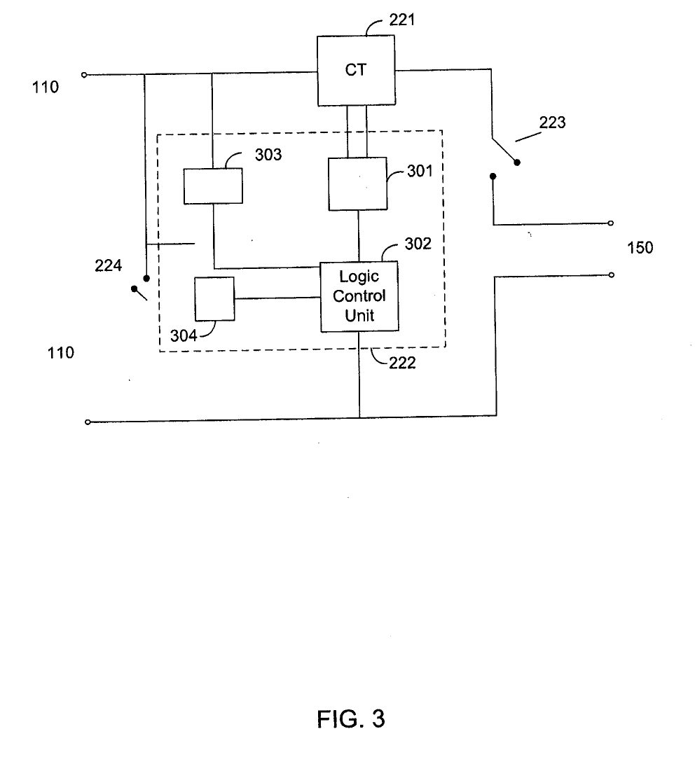

Control circuit 222 can comprise various structures for monitoring the condition of the secondary winding of current transformer 221 and/or input voltage 110 and controlling the operation of switch 223. In an exemplary embodiment and with reference to FIG. 3, control circuit 222 includes a current sensor 301 and a logic control unit 302. Current sensor 301 monitors the output of a current measuring system, such as for example, the secondary winding of current transformer 221, which is an AC voltage proportional to the load current. Also, current sensor 301 provides a signal to logic control unit 302. In one embodiment, the signal is a DC voltage proportional to the current monitored by current sensor 301. In another embodiment, the signal is a current proportional to the current monitored by current sensor 301.

In an exemplary embodiment, logic control unit 302 is powered by an energy storage capacitor. Logic control unit 302 may briefly connect the storage capacitor to power input 110 in order to continue powering logic control unit 302. In another embodiment, logic control unit 302 is powered by a battery or other energy source. This energy source is also referred to as housekeeping or hotel power; it functions as a low auxiliary power source. In one embodiment, auxiliary power is taken from power input 110. For further detail on similar current monitoring, see U.S. Pat. No. 7,795,760, entitled “LOAD CONDITION CONTROLLED POWER MODULE,” which is hereby incorporated by reference.

In an exemplary embodiment, logic control unit 302 is a microprocessor capable of being programmed prior to, and after integration in inline power adapter controller 100. In one embodiment, a user is able to connect to logic control unit 302 and customize the parameters of inline power adapter controller 100. For example, a user may set the threshold level and a sleep mode duty cycle of inline power adapter 100. Data from inline power adapter controller 100 could be transmitted regarding, for example, the historical power consumption and/or energy saved. The bidirectional data transfer between inline power adapter controller 100 and a display device may be achieved through a wireless signal, such as for example, an infra-red signal, a radio frequency signal, or other similar signal. The data transfer may also be achieved using a wired connection, such as for example, a USB connection or other similar connection. In another embodiment, switch 224 is used to set the parameters of inline power adapter controller 100 by the duration of the switch 224 closure.

In accordance with an exemplary embodiment, control circuit 222 further comprises a power disconnect 303 in communication with logic control unit 302. Power disconnect 303 is configured to isolate logic control unit 302 from power input 110 and reduce power loss. While isolated, logic control unit 302 is powered by the storage capacitor or other energy source and logic control unit 302 enters a sleep mode. If the storage capacitor reaches a low power level, power disconnect 303 is configured to reconnect logic control unit 302 to power input 110 to recharge the storage capacitor. In an exemplary embodiment, power disconnect 303 is able to reduce the power loss from a range of microamperes of leakage current to a range of nanoamperes of leakage current.

In another exemplary embodiment, control circuit 222 receives a control signal that is impressed upon power input 110 by another controller. The control signal may be, for example, the X10 control protocol or other similar protocol. Control circuit 222 may receive the control signal through the secondary winding of current transformer 221, from a coupled power input 110, or any other suitable means configured to couple power input 110 to control circuit 222 as now known or hereinafter devised. This control signal may come from within inline power adapter controller 100 or may come from an external controller. The control signal may be a high frequency control signal or at least a control signal at a frequency different than the frequency of power input 110. In an exemplary embodiment, control circuit 222 interprets the high frequency control signal to engage or disengage switch 223. In another embodiment, an external controller transmits a signal to turn inline power adapter controller 100 to an “on” or “off” condition.

In an exemplary embodiment, if behavior of the secondary winding of current transformer 221 indicates that power output 150 is drawing substantially no power from power input 110, switch 223 facilitates or controls disengaging of the primary circuit of current transformer 221 from power output 150, i.e., switch 223 facilitates the disengaging of a power source from power outlet 120. In an exemplary embodiment, the secondary winding of current transformer 221 is monitored for an AC waveform at the AC line frequency of power input 110, where the AC waveform has an RMS voltage proportional to the load current passing through the primary circuit of current transformer 221 to power output 150. In another embodiment, the AC waveform is rectified and filtered to generate a DC signal before being received by control circuit 222. The DC signal is proportional to the load current passing through the primary circuit of current transformer 221 to power output 150.

In one embodiment, the phrase “substantially no power” is intended to convey that the output power is in the range of approximately 0-1% of a typical maximum output load. In an exemplary embodiment, switch 223 is configured to control the connection of the primary circuit of current transformer 221 to power output 150 and comprises a switching mechanism to substantially disengage the primary circuit of current transformer 221 from power output 150. Switch 223 may comprise at least one of a relay, latching relay, a TRIAC, and an optically isolated TRIAC.

By substantially disabling the primary circuit of current transformer 221, the power consumption at power output 150 is reduced. In one embodiment, substantially disabling power output 150 is intended to convey that the output signal of the secondary winding of current transformer 221 has been interpreted by control circuit 222 as sufficiently low so that it is appropriate to disengage switch 223 and remove power from power output 150.

In another exemplary embodiment, and with reference to FIGS. 2 and 3, control circuit 120 further comprises a reconnection device 224, which is configured to enable the closure of switch 223 through logic control unit 302. The closure of switch 223 reconnects power output 150 to the primary circuit of current transformer 221 and power input 110. In an exemplary embodiment, reconnection device 224 comprises a switch device that may be closed and opened in various manners. For example, reconnection device 224 (user input 130 of FIG. 1A) can comprise a push button that may be manually operated. In one embodiment, the push button is located on the face of inline power adapter controller 100. In another embodiment, reconnection device 224 is affected remotely by signals traveling through power input 110 that control circuit 222 interprets as on/off control. In yet another embodiment, reconnection device 224 is controlled by a wireless signal, such as for example, an infra-red signal, a radio frequency signal, or other similar signal.

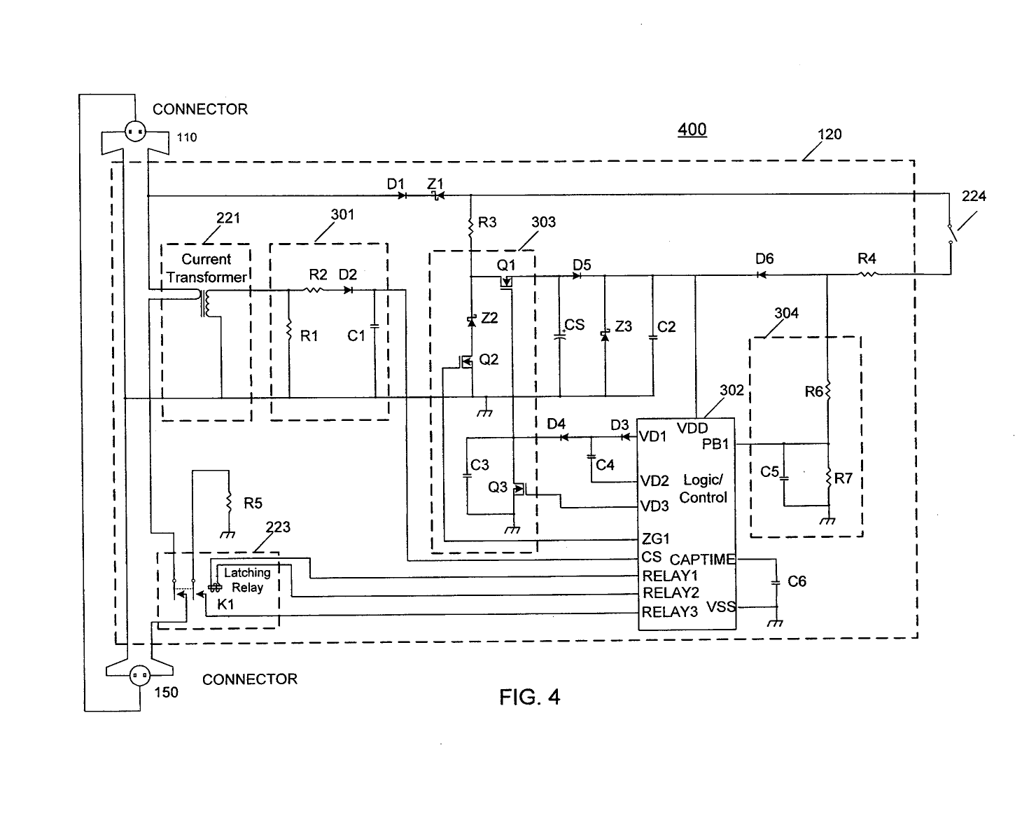

In an exemplary embodiment, and with reference to FIGS. 3 and 4, control circuit 120 further comprises a reconnection device memory state 304. Reconnection device memory state 304 is configured to indicate whether reconnection device 224 was recently activated so that logic control unit 302 can determine the circuit conditions upon power up. In the exemplary embodiment, reconnection device memory state 304 comprises a capacitor C5, which charges when reconnection device 224 is activated. Logic control unit 302 can then measure the voltage on capacitor C5 as an indication of whether reconnection device 224 was activated. In one exemplary embodiment, reconnection device memory state 304 provides a digital reading to the PB1 input of logic control unit 302. If there is sufficient voltage at capacitor C5, the PB1 input reads a “1”. If there is insufficient voltage at capacitor C5, the PB1 input reads a “0”. The determination of what voltage is sufficient is dependent in part on the ratio of resistors R6 and R7 and can be interpreted by logic control unit 302, as would be known to one skilled in the art. Capacitor C5 serves to store the state of reconnection device 224 until the voltage of capacitor C5 can be read by logic control unit 302.

In accordance with another exemplary embodiment, switch 223 is automatically operated on a periodic basis. For example, switch 223 may automatically reconnect after a few or several minutes or tens of minutes, or any period more or less frequent. In one embodiment, switch 223 is automatically reconnected frequently enough that a battery operated device connected to inline power adapter controller 100 will not completely discharge internal batteries during a period of no power at the input to the connected device. After power output 150 is reconnected, in an exemplary embodiment, control circuit 120 tests for or otherwise assesses load conditions, such as the power demand at power output 150. If the load condition on power output 150 is increased above previously measured levels, power output 150 will remain connected to the primary circuit of current transformer 221 until the load condition has returned to a selected or predetermined threshold level indicative of a “low load”. In other words, if the power demand at power output 150 increases, power is provided to power output 150 until the power demand drops and indicates a defined idle mode. In an exemplary embodiment, the determination of load conditions at re-connect are made after a selected time period had elapsed, for example after a number of seconds or minutes, so that current inrush or initialization events are ignored. In another embodiment, the load conditions may be averaged over a selected time period of a few seconds or minutes so that short bursts of high load average out. In yet another exemplary embodiment, inline power adapter controller 100 comprises a master reconnection device that can re-engage all power outputs 150 to power input 110.

In an exemplary method of operation, inline power adapter controller 100 has switch 223 closed upon initial power-up, such that power flows to power output 150. When load conditions at power output 150 are below a threshold level, control circuit 222 opens switch 223 to create an open circuit and disengage power output 150 from the input power signal. This disengaging effectively eliminates any idle power lost by power output 150. In one embodiment, the threshold level is a predetermined level, for example approximately one watt of power or less flowing to power output 150.

In an exemplary embodiment, different power outputs 150 may have different fixed threshold levels such that devices having a higher power level in idle may be usefully connected to inline power adapter controller 100 for power management. For example, a large device may still draw about 5 watts during idle, but would never be disconnected from power input 110 if the connected power output 150 had a threshold level of about 1 watt. In various embodiments, certain power outputs 150 may have a higher threshold levels to accommodate high power devices, or lower threshold levels for lower power devices.

In another embodiment, the threshold level is a learned level. The learned level may be established through long term monitoring by control circuit 222 of load conditions at power output 150. A history of power levels is created over time by monitoring and may serve as a template of power demand. In an exemplary embodiment, control circuit 222 examines the history of power levels and decides whether long periods of low power demand were times when a device connected at power output 150 was in a low, or lowest, power mode. In an exemplary embodiment, control circuit 222 disengages power output 150 during low power usage times when the period of low power matches the template. For example, the template might demonstrate that the device draws power through power output 150 for eight hours, followed by sixteen hours of low power demand.

In another exemplary embodiment, control circuit 222 determines the approximate low power level of the electronic device connected at power output 150, and sets a threshold level to be a percentage of the determined approximate low power level. For example, control circuit 222 may set the threshold level to be about 100-105% of the approximate low power level demand. In another embodiment, the threshold demand may be set at about 100-110% or 110-120% or more of the approximate low level power demand. In addition, the low power level percentage range may be any variation or combination of the disclosed ranges. In another embodiment, switch 224 is used to set the parameters of inline power adapter controller 100 by the duration of the switch 224 closure.

Having disclosed various functions and structures for an exemplary inline power adapter controller configured for reducing or eliminating power during idle mode of a legacy power adapter by disengaging power input, a detailed schematic diagram of an exemplary inline power adapter controller 400 is provided in accordance with an exemplary embodiment. With reference to FIG. 4, in an exemplary embodiment of inline power adapter controller 400, control circuit 120 comprises current transformer 221, current sensor 301, logic control unit 302, power disconnect 303, reconnection device memory state 304, and switch 223.

In one embodiment, current transformer 221 and current sensor 301 combine to measure the current from power input 110 and convert said current to a proportional DC voltage that can be read by logic control unit 302. Furthermore, switch 223 may comprise a latching relay, e.g., relay coil K1, that provides a hard connect/disconnect of power input 110 to power output 150 after a command from logic control unit 302. Switch 223 alternates between open and closed contacts. Furthermore, switch 223 holds its position until reset by logic control unit 302, and will hold position without consuming any power in a relay coil K1.

In an exemplary embodiment, logic control unit 302 comprises a microcontroller that receives input of the current in the power input line, controls the state of switch 223 and reads or otherwise assesses the state or position of the contacts of reconnection device 224 and switch 223. In addition, logic control unit 302 learns and stores the power profile for an electronic device connected to power output 150. In another exemplary embodiment, control circuit 120 further comprises reconnection device 224 and reconnection device memory state 304. Reconnection device 224 is activated to turn on power output 150 when control circuit 120 is first connected to power input 110 or when full power is needed immediately at power output 150. Reconnection device memory state 304 is configured to indicate to logic control unit 302 whether reconnection device 224 was recently activated.

In an exemplary embodiment, power disconnect 303 comprises a network of transistors Q1, Q2, Q3 which are used in conjunction with zener diodes Z1, Z2 to condition power input 110 to a safe level suitable for logic control unit 302 and isolate logic control unit 302 from power input 110. In another embodiment, power disconnect 303 comprises relays in addition to, or in place of, the transistors of the prior embodiment.

Initial connection of inline power adapter controller 400 involves connecting inline power adapter controller 400 to a power source which may be accomplished by coupling one or more components of a legacy power adapter to inline power adapter 400. The power source may be AC or DC. In an exemplary method, upon initial plug-in of inline power adapter controller 400 to a power source, all circuits of control circuit 120 are dead and switch 223 is in the last position or state set by logic control unit 302. This initial condition may or may not provide power to power output 150. When all the circuits are dead, there is no current flow into control circuit 120. This is due to the isolation provided by power disconnect 303 and reconnection device 224 in a normal, open position. In an exemplary embodiment, power disconnect 303 comprises transistors Q1, Q2, Q3 and capacitor C3. In this state, only leakage current will flow through transistors Q1, Q2 and the leakage current will be on the order of approximately tens of nanoamperes. Furthermore, current transformer 221 provides dielectric isolation from primary side to secondary side so that only small leakage current flows due to the inter-winding capacitance of current transformer 221.

With continued reference to FIG. 4, in an exemplary embodiment and for illustration purposes, a user may reconnect the circuit using reconnection device 224 to establish a current path through diode D1, zener diode Z1, reconnection device 224, resistor R4, diode D6, and zener diode Z3. Diode D1 serves to half-wave rectify the AC line to drop the peak to peak voltage in half. Zener diode Z1 further reduces the voltage from diode D1, for example to about 20 volts. Zener diode Z3 and resistor R4 form a current limited zener regulator that provides an appropriate DC voltage at the VDD input to logic control unit 302 while reconnection device 224 is held. In addition, capacitor C2 smoothes the DC signal on zener diode Z3 and provides storage during the contact bounce of reconnection device 224. Capacitor C2 is sized to provide sufficient storage during the start-up time of logic control unit 302, and capacitor C2 in combination with resistor R4 provides a fast rising edge on the VDD input to properly reset logic control unit 302. Furthermore, diode D5 isolates capacitor C2 from capacitor CS so the rise time constant of capacitor C2 and resistor R4 is not affected by the large capacitance of capacitor CS. When capacitor CS is powering logic control unit 302, the current of capacitor CS passes through diode D5. Diode D6 serves to isolate the voltage on capacitor C2 when reconnection device 224 is released. This allows the voltage stored on capacitor C5 during the closed time of reconnection device 224 to be retained when reconnection device 224 is open and inform logic control unit 302 of the open condition.

In an exemplary method, if reconnection device 224 is activated for a few milliseconds, logic control unit 302 is configured to initialize and immediately set up to provide its own power before reconnection device 224 is released. This is accomplished from voltage doubler outputs VD1-VD3 and ZG1 of logic control unit 302. First, output ZG1 is driven high to turn on transistor Q2. With transistor Q2 on, a current path is established through resistor R3 and zener diode Z2 providing a regulated voltage at the drain of transistor Q1. This regulated voltage is similar to that produced by zener diode Z3 and is appropriate for the VDD input of logic control unit 302. Second, after the voltage on zener diode Z2 has stabilized for a few microseconds, outputs VD1-VD3 of logic control unit 302 begin switching to produce a gate drive signal to turn on transistor Q1. The signals produced by outputs VD1-VD3 and components including capacitor C3, transistor Q3, capacitor C4, diode D3 and diode D4 produce a voltage at the gate of transistor Q1 that is about twice the voltage on VDD input of logic control unit 302. This voltage doubling turns transistor Q1 on hard. Once transistor Q1 is on, the voltage at zener diode Z2 charges capacitor CS. In an exemplary embodiment, capacitor CS is a large storage capacitor that is used to power logic control unit 302 when reconnection device 224 is not being activated. After capacitor CS has been charged for a few milliseconds, outputs VD1-VD3 and ZG1 return to a rest state and transistors Q1 and Q2 are turned off. In this embodiment, logic control unit 302 is operating off the stored charge in capacitor CS and not drawing power from power input 110. When reconnection device 224 is no longer active, capacitor CS will continue to power logic control unit 302.

If power output 150 is idling and drawing substantially no power, logic control unit 302 may be able to disengage from drawing power and enter a “sleep” mode. In an exemplary method, and with further reference to FIG. 4, when logic control unit 302 is operating from the stored energy in capacitor CS, a timing function is enabled in logic control unit 302 that uses capacitor C6 to perform the timing function. Capacitor C6 is briefly charged by the CAPTIME output of logic control unit 302 and over time capacitor C6 discharge rate will mimic the decay of the voltage on capacitor CS. Once capacitor C6 voltage at input CAPTIME reaches a low level, logic control unit 302 will set the state of outputs VD1-VD3 and ZG1 to again recharge capacitor CS from the AC line. This process repeats over and over so power is never lost to logic control unit 302. The recharge process takes only a few milliseconds or less to operate, depending on the size of capacitor CS.

Furthermore, in an exemplary method, when logic control unit 302 is not busy recharging capacitor CS, switching relay K1, or measuring power drawn from power output 150, logic control unit 302 is operating in a deep sleep mode that stops all, or substantially all, internal activity and waits for capacitor C6 to discharge. This sleep mode consumes very little power and allows the charge on storage capacitor CS to persist for many seconds. If reconnection device 224 is activated during the sleep mode, capacitor C5 will be recharged and logic control unit 302 will resume normal operation and set or reset relay K1. Alternatively, if capacitor C6 voltage falls too low, logic control unit 302 will again recharge capacitor CS and then return to sleep mode.

While an electronic device is in an idle mode, inline power adapter controller 100 may continue to monitor for changes in the power drawn by the electronic device. In an exemplary method, while logic control unit 302 continuously goes in and out of sleep mode to re-power itself, logic control unit 302 will also periodically test the power being drawn from power output 150. The period of power testing is much greater than that of capacitor CS charging and, for example, may be only tested every ten or more minutes. In accordance with an exemplary method, there are at least three possible outcomes from the result of power testing: 1) the device is operating and the switch is not in standby condition, 2) the device is not operating but the switch is not in a standby condition, or 3) the switch is in a standby condition.

For the outcome when the device is operating and the switch is not in a standby condition, relay K1 has been previously set to deliver power to power output 150 and power testing shows an appreciable load current is being drawn by the electronic device connected. An “appreciable load” may be defined by some fixed value programmed into logic control unit 302, or it may be the result of a number of power tests and be the typical load current for this electronic device. A power test result here will be interpreted as normal conditions and logic control unit 302 will go back into sleep mode cycling until another time period, such as ten minutes, has passed when the power test will be made again. In another exemplary embodiment, the duration of the sleep mode cycling is determined by a user. For example, a user may set the sleep mode duration to be one, two, or five minutes and may do so using a dial, a digital input, a push button, keypad or any other suitable means now know or hereinafter devised.

For the outcome when the device is not operating but the switch is not in a standby condition, relay K1 has been previously set to deliver power to power output 150 and power testing shows a negligible load current being drawn by the device connected. The “negligible load” may be some fixed value programmed into logic control unit 302, or it may be the result of a number of power tests and be the typical minimum found for this electronic device. In either case the action taken by logic control unit 302 will be to set relay K1 to an open condition by using outputs RELAY1-RELAY2 of logic control unit 302 to energize relay coil K1. The state of relay K1 is determined by logic control unit 302 testing for the presence of resistor R5 at RELAY3, since logic control unit 302 may not know the previous state of relay K1, for example, starting from power off state.

For the outcome when the switch is in a standby condition, that is, relay K1 has been set to remove power from power output 150, logic control unit 302 must set relay K1 to a closed condition to allow AC power to be applied to the power output. In an exemplary method, once relay K1 is set, a period of time is allowed to elapse before the power testing is done. This delay allows for the electronic device attached to power output 150 to initialize and enter a stable operating mode. Power measurements may now be made over some period of time to determine if the electronic device is in a low or high power state. If a high power state is determined, relay K1 remains set. If a low power state is determined, relay K1 is reset to open condition and power is again removed from power output 150. Also, logic control unit 302 will again begin sleep mode cycling and power testing after a determined time period, for example, every ten minutes.

If a user wants to operate a device that is connected to power output 150 and that power output is turned off, in an exemplary embodiment, activating reconnection device 224 will immediately wake logic control unit 302 from sleep mode. Since the wake up was from the activation of reconnection device 224 and not due to power testing or capacitor CS recharging, logic control unit 302 will immediately set relay K1 to closed position to power the electronic device connected to power output 150.

In addition to the embodiments described above, various other elements may be implemented to enhance control and user experience. One way to enhance user control is to allow a user to select the operating mode of a power output. In an exemplary embodiment, inline power adapter controller 100 further comprises a “Green Mode” switch that enables or disables the “green” mode operation. The green mode switch may be a hard, manual switch or it may be a signal to logic control unit 302. “Green” mode operation is the disengaging of power output 150 from power input 110 when substantially no load is being drawn at power output 150. A user may use the green mode switch to disenable green mode operation on various power outputs when desired. For instance, this added control may be desirable on power outputs that power devices with clocks or devices that need to be instantly on, such as a fax machine.

In one embodiment, inline power adapter controller 100 includes LED indicators, which may indicate whether a power output is connected to the power line and drawing a load current. The LED indicators may indicate that whether a power output is active, that is, power is drawn by an electronic device and/or the power output has power available even if an electronic device is not connected. In addition, a pulsing LED may be used to show when power testing is being done or to indicate the “heartbeat” of sleep mode recharging.

In another embodiment, inline power adapter controller 100 comprises at least one LCD display. The LCD display may be operated by logic control unit 302 to indicate the load power being provided to power output 150, for example during times of operation. The LCD may also provide information about the power saved or power consumed by operating inline power adapter controller 100 in or out of a “green” mode. For example, LCD may display the sum total of watts saved during a certain time period, such as the life of inline power adapter controller 100 or in a day.

Various embodiments may also be used to enhance the efficient use of the inline power adapter controller and/or individual power outputs in the inline power adapter controller. One such embodiment is the implementation of a photocell or other optical sensor monitored by logic control unit 302. The photocell determines whether light is present in the location of inline power adapter controller 100 and logic control unit 302 can use this determination to disengage power output 150 depending on the ambient light conditions. For example, logic control unit 302 may disengage power output 150 during periods of darkness. In other words, the power outputs of the inline power adapter controller may be turned off at night. Another example is devices do not need power if located in a dark room, such as an unused conference room in an office. Also, the power outputs may be turned off when the ambient light conditions exceed a certain level, which may be predetermined or user determined.

In another embodiment, inline power adapter controller 100 further comprises an internal clock. Logic control unit 302 may use the internal clock to learn which time periods show a high power usage at power output 150. This knowledge may be included to determine when a power output should have power available. In an exemplary embodiment, the internal clock has quartz crystal accuracy. Also, the internal clock does not need to be set to an actual time. Furthermore, the internal clock may be used in combination with the photocell for greater inline power adapter controller efficiency and/or accuracy.

The present invention has been described above with reference to various exemplary embodiments. However, those skilled in the art will recognize that changes and modifications may be made to the exemplary embodiments without departing from the scope of the present invention. For example, the various exemplary embodiments can be implemented with other types of power strip circuits in addition to the circuits illustrated above. These alternatives can be suitably selected depending upon the particular application or in consideration of any number of factors associated with the operation of the system. Moreover, these and other changes or modifications are intended to be included within the scope of the present invention.

What is claimed is:

1. A power converter system configured to provide power to an electronic device, comprising:
a power converter configured to condition power from a power source and transmit power to the electronic device; and
a power controller configured to selectively couple to the power converter between at least one of the power source and the electronic device and wherein the power controller is configured to disengage the power to the electronic device in response to the electronic device operating under a predetermined operating condition.

2. The power converter system of claim 1, wherein the predetermined operating condition is at least one of an idle mode or sleep mode.

3. The power converter system of claim 1, wherein the predetermined operating condition is a predetermined battery charge threshold.

4. The power converter system of claim 1, wherein the power controller removably couples to the power converter.

5. The power converter system of claim 1, wherein the power controller is configured to measure a current drawn by the electronic device from at least one of the power source and the power converter.

6. The power converter system of claim 1, wherein the power controller comprises a control circuit configured to monitor and disengage the power.

7. The power converter system of claim 6, wherein the power controller further comprises a user input in communication with the control circuit, and wherein in response to receiving an input from a user, the control circuit does not disengage power.

8. A power controller configured to removably couple between a power converter and an electronic device in order to reduce power consumption during idle operation of the electronic device, the power controller comprising:
a power input that when coupled to the power converter is configured to receive power from at least one of a power supply and the power converter; and
a control circuit configured to monitor the power and disengage the power to the electronic device in response to the electronic device drawing substantially no power.

9. The power controller of claim 8, wherein the power controller is configured to receive the power from the power source and transmit the power to the power converter.

10. The power controller of claim 8, wherein the power controller is configured to receive the power from the power converter and transmit the power to the electronic device.

11. The power controller of claim 8, wherein the power controller is configured with a male connector to removably couple to the power source and a female connector to removably couple to the power converter.

12. The power controller of claim 8, wherein the power controller is configured as a cord.

13. The power controller of claim 13, wherein the power converter comprises a power input wire and a power output wire, and wherein the power controller is configured to replace at least one of the power input wire and the power output wire.

14. A method for providing power to an electronic device, comprising:
receiving, by a power converter, power to be provided to an electronic device;
monitoring, by a control circuit of a power controller, the current drawn by the electronic device; and
inhibiting, by the control circuit, the power to the electronic device in response to detection of a predetermined operating condition.
